(19) United States
(12) Patent Application Publication
(10) Pub. No.: US 2026/0288035 A1
(43) Pub. Date: Sep. 24, 2026

(54) DEVELOPING APPARATUS

(71) Applicant: CANON KABUSHIKI KAISHA, Tokyo (JP)

(72) Inventor: Akisato Ohashi, Ibaraki (JP)

(21) Appl. No.: 19/567,669

(22) Filed: Mar. 16, 2026

(30) Foreign Application Priority Data
Mar. 21, 2025 (JP) 2025-046979

(51) Int. Cl. G03G 15/08

(52) U.S. Cl. CPC G03G 15/0898; G03G 15/0812; G03G 15/0815; G03G 15/0818; G03G 15/0891

(57) ABSTRACT

A magnet is non-rotationally disposed inside a developer bearing member and includes a plurality of magnetic poles. The magnet includes a first magnetic pole and a second magnetic pole. The second magnetic pole is positioned adjacent to the first magnetic pole and has a same polarity as the first magnetic pole. A low magnetic force portion having a magnetic force of equal to or less than 10 milli-Tesla is formed in a region upstream of the first magnetic pole and downstream of the second magnetic pole. A partition wall includes an opening portion formed at a position facing the low magnetic force portion with the developer bearing member interposed therebetween, and a flow path portion configured to guide air entering from the opening portion to an outside of the developing container.

### BACKGROUND

### Field of the Technology

The present disclosure relates to a developing apparatus that develops an electrostatic latent image formed on an image bearing member, such as a photosensitive drum, with toner.

### Description of the Related Art

An image forming apparatus includes a developing apparatus that develops an electrostatic latent image formed on a photosensitive drum (image bearing member) using a developer containing a toner and a carrier. The developing apparatus forms an image by bearing the developer, which is accommodated in a developing container, on a developing roller (a developer bearing member) and by conveying the developer to a region where the developing roller faces the photosensitive drum. At this time, the rotation of the developing roller increases pressure inside the developing container, and generates an airflow from inside to outside the developer container. Then, the developer inside the developing container may scatter to the outside and contaminate the interior of the image forming apparatus.

In addition, in a case of the developing apparatus including a first chamber that supply the developer to the developing roller, a second chamber that collect the developer separated from the developing rollers, and a partition wall that divide the first chamber and the second chamber, a rotational direction of the developing roller is a direction in which a surface of the developing roller exits the first chamber to the outside of the developing apparatus and enters the second chamber. At this time, in the developing apparatus, a local pressure increase occurs in the second chamber. For this reason, Japanese Patent Laid-Open No. 2012-108234 discloses a configuration in which an opening portion is formed in a surface of the partition wall facing the second chamber, and a flow path portion to guide air entering from the opening portion to the outside of the developing container is formed inside the partition wall.

In Japanese Patent Laid-Open No. 2012-108234, since the opening portion disposed in the partition wall faces the second chamber, a portion of the opening portion may become obstructed by the developer scattering within the second chamber. Therefore, in the case of Japanese Patent Laid-Open No. 2012-108234, air does not readily flow from the second chamber through the opening portion and the flow path portion, which may prevent the pressure increase in the second chamber from being sufficiently suppressed. As a result, the increased pressure in the second chamber may cause the toner to scatter to the outside of the developing apparatus.

### SUMMARY

The present disclosure provides a configuration that can suppress toner scattering from a developing apparatus to the outside.

According to one aspect of the present disclosure, a developing apparatus is configured to develop an electrostatic latent image formed on an image bearing member with toner. The developing apparatus includes a developer bearing member configured to bear and convey a developer containing the toner and a carrier, a developing container configured to accommodate the developer, the developing container including, a first chamber configured to accommodate the developer that is supplied to the developer bearing member, a second chamber configured to collect the developer separated from the developer bearing member, a partition wall configured to divide the first chamber and the second chamber, the partition wall including a first communicating portion configured to communicate between the second chamber and the first chamber such that the developer is allowed to move from the second chamber to the first chamber and a second communicating portion configured to communicate between the second chamber and the first chamber such that the developer is allowed to move from the first chamber to the second chamber, a first conveyance member disposed in the first chamber and configured to convey the developer in a first direction from the first communicating portion toward the second communicating portion, a second conveyance member disposed in the second chamber and configured to convey the developer in a second direction from the second communicating portion toward the first communicating portion, and, a magnet non-rotationally disposed inside the developer bearing member and including a plurality of magnetic poles arranged in a rotational direction of the developer bearing member, the magnet being configured to generate a magnetic field that allows the developer bearing member to bear the developer. The magnet includes a first magnetic pole and a second magnetic pole. The second magnetic pole is positioned adjacent to the first magnetic pole on an upstream side in the rotational direction of the developer bearing member, has a same polarity as the first magnetic pole, and is configured to separate the developer on the developer bearing member by a repulsive magnetic field generated in cooperation with the first magnetic pole. A low magnetic force portion having a magnetic force of equal to or less than 10 milli-Tesla is formed in a region upstream of the first magnetic pole and downstream of the second magnetic pole in the rotational direction of the developer bearing member. The partition wall includes an opening portion formed at a position facing the low magnetic force portion with the developer bearing member interposed therebetween, and a flow path portion configured to guide air entering from the opening portion to an outside of the developing container.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating a schematic configuration of an image forming apparatus according to a first embodiment.

FIG. 2 is a perspective view illustrating a schematic configuration of a developing apparatus according to the first embodiment.

FIG. 3 is a cross-sectional view illustrating a schematic configuration of the developing apparatus according to the first embodiment.

FIG. 4 is a perspective view illustrating a developing roller according to the first embodiment.

FIG. 5 is a cross-sectional view illustrating the developing roller according to the first embodiment.

FIG. 6 is a cross-sectional view taken along the line A-A of FIG. 3.

FIG. 7 is an enlarged cross-sectional view illustrating a portion of FIG. 6.

FIG. 8 is a cross-sectional view taken along the line B-B of FIG. 6.

FIG. 9 is a cross-sectional view illustrating a schematic configuration of a developing apparatus according to a second embodiment, which corresponds to the A-A cross-section of FIG. 3.

### DESCRIPTION OF THE EMBODIMENTS

### First Embodiment

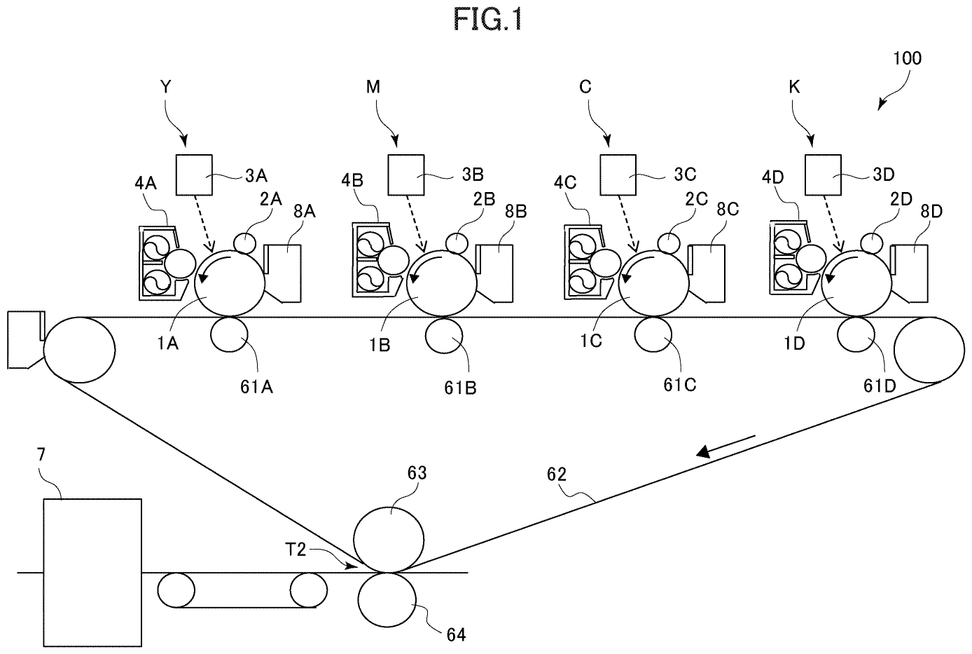

A first embodiment will be described with reference to FIGS. 1 to 8. First, a schematic configuration of an image forming apparatus of the present embodiment will be described with reference to FIG. 1.

### Image Forming Apparatus

The image forming apparatus 100 employs a configuration of a so-called tandem system in which image forming units Y, M, C, and K which form toner images of four colors of yellow, magenta, cyan, and black are disposed along a rotational direction of an intermediate transfer belt 62. The image forming apparatus 100 forms the toner image (image) on a recording material according to image signals received from a document reading apparatus (not shown) connected to an image forming apparatus body, or from host equipment communicatively connected to the apparatus body, such as a personal computer. The recording material includes sheet materials such as paper, plastic films, and cloth.

To be noted, the four image forming units Y, M, C, and K included in the image forming apparatus 100 have substantially identical configurations except for differences in developing colors. Therefore, hereinafter, the image forming unit Y will be described as a representative, and descriptions of the other image forming units will be omitted.

A cylindrical photosensitive member, namely a photosensitive drum 1A, serving as an image bearing member, is disposed in the image forming unit Y. The photosensitive drum 1A is rotatably driven in an arrow direction illustrated in FIG. 1. To be noted, in the present embodiment, a rotational axis direction of the photosensitive drum 1A is defined as a longitudinal direction. In addition, in the longitudinal direction, a side on which the photosensitive drum 1A receives a driving force from the image forming apparatus body is referred to as a drive side, while the opposite side is referred to as a non-drive side. A charge roller 2A (charging apparatus), a developing apparatus 4A, a primary transfer roller 61A, and a cleaning apparatus 8A are arranged around the photosensitive drum 1A. A laser scanner (exposing apparatus) 3A is arranged above the photosensitive drum 1A in FIG. 1.

In addition, the intermediate transfer belt 62, serving as an intermediate transfer member, is disposed opposite the photosensitive drums 1A, 1B, 1C, and 1D. The intermediate transfer belt 62 is stretched around a plurality of stretching rollers, and moves circumferentially (rotates) in the arrow direction in FIG. 1 by being driven by a drive roller included in the plurality of stretching rollers. A secondary transfer outer roller 64 is disposed at a position opposite a secondary transfer inner roller 63, which is included in the plurality of stretching rollers, across the intermediate transfer belt 62, and forms a secondary transfer portion T2 that transfers the toner image on the intermediate transfer belt 62 onto the recording material. A fixing unit 7 is disposed downstream of the secondary transfer portion T2 in a recording material conveyance direction.

Image formation in the image forming apparatus 100, which is configured as described above, is performed as follows. First, a surface of the photosensitive drum 1A is uniformly charged by the charge roller 2A. When the charge roller 2A becomes contaminated by floating toner or the like, it becomes unable to uniformly charge the photosensitive drum 1A; therefore, the apparatus is configured such that a charging cleaning roller (not shown), which is disposed opposite the charge roller 2A, cleans an outer circumferential surface of the charge roller 2A and reduces contamination.

An electrostatic latent image is formed on the photosensitive drum 1A by exposing the charged surface of the photosensitive drum 1A by the laser scanner 3A. The image signals of yellow, magenta, cyan, and black are respectively input to the laser scanners 3A, 3B, 3C, and 3D, and, in accordance with these image signals, the surfaces of photosensitive drums 1A, 1B, 1C, and 1D are irradiated with laser beams; thereby, electric charges are neutralized, and the latent images are formed. The electrostatic latent image obtained as described above is developed into the toner image by adhering the toner from the developing apparatus 4A. This toner image is transferred onto the intermediate transfer belt 62 by the primary transfer roller 61A. These operations are sequentially performed also in the image forming units M, C, and K, and the toner images of the four colors are superimposed on the intermediate transfer belt 62.

Then, after superimposing and transferring the toner images of the four colors onto the intermediate transfer belt 62, the toner images of the four colors are transferred onto the recording material conveyed from a feed cassette (not shown) to the secondary transfer portion T2. This recording material is heated and pressurized by the fixing unit 7 for fixation, and thereafter discharged outside the image forming apparatus 100. Residual toner remaining on the photosensitive drum 1A after the transfer is removed by the cleaning apparatus 8A.

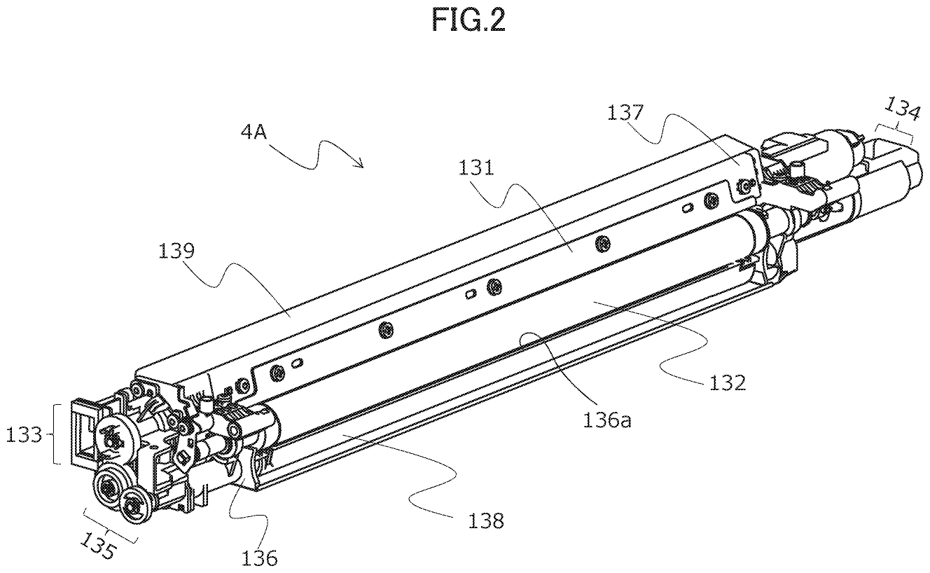

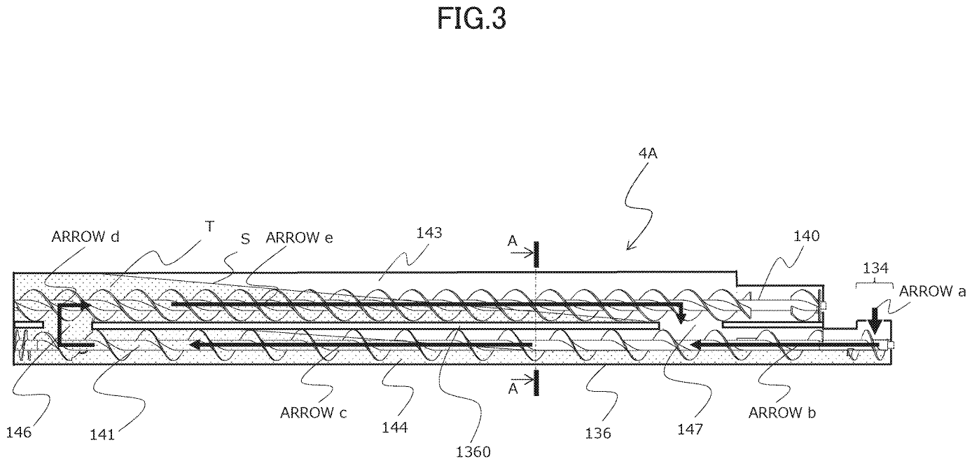

Next, the developing apparatus 4A of the present embodiment will be described with reference to FIGS. 2 and 3. To be noted, the other developing apparatuses 4B, 4C, and 4D have the same configuration as the developing apparatus 4A, and thus descriptions and illustrations thereof will be omitted.

As illustrated in FIG. 2, the developing apparatus 4A includes a developing container 136, a cylindrical developing roller 132 (developing rotary member), serving as a developer bearing member, and a regulation plate 131, serving as a regulation member. The developing container 136 can accommodate developer containing non-magnetic toner and a magnetic carrier. A cover member 139 made of a resin material is attached to the developing container 136. In the developing container 136, an opening 136a is formed in a portion facing the photosensitive drum 1A (FIG. 1), and the developing roller 132 is rotatably disposed so as to be partially exposed through the opening 136a.

The developing roller 132 is disposed to face the photosensitive drum 1A, and, by rotating, bears and conveys the developer within the developing container to a region (developing region) facing the photosensitive drum 1A, thereby, the electrostatic latent image on the photosensitive drum 1A (on the image bearing member) is developed. The developing roller 132 is disposed such that its rotational axis direction becomes substantially parallel to the rotational axis direction of the photosensitive drum 1A. The regulation plate 131 is opposed to an outer circumference of the developing roller 132 with a predetermined gap. The regulation plate 131 is mounted to a regulation plate support member 137 that is mounted to the developing container 136. The regulation plate 131 regulates a layer thickness of the developer borne on the developing roller 132 by positioning its leading edge to face an outer circumferential surface of the developing roller 132 with the predetermined gap therebetween.

A driving force transmission member 135, such as a gear or coupling, for transmitting a driving force to rotatably drive the developing roller 132 is disposed on a side of one end of the developing apparatus 4A in the longitudinal direction (the rotational axis direction of the developing roller 132). In addition, a supply port 134 for supplying the developer from a developer replenishment container (not shown) to the developing container 136 during the image formation is formed at the other end portion of the developing container 136 in the longitudinal direction. A ventilation port 133 for depressurizing an interior of the developing container 136 is formed at one end portion of the developing container 136 in the longitudinal direction.

As illustrated in FIG. 3, the developing container 136 is divided into a supply chamber 143 and a collection chamber 144 by a partition wall 1360 which extends in the longitudinal direction. The supply chamber 143, serving as a first chamber, accommodates the developer to be supplied to the developing roller 132.

The collection chamber 144, serving as a second chamber, collects the developer separated from the developing roller 132. In the present embodiment, the supply chamber 143 is disposed above the collection chamber 144. The partition wall 1360 divides the supply chamber 143 from the collection chamber 144. A first conveying screw 140, serving as a first conveying member, and a second conveying screw 141, serving as a second conveying member, are respectively disposed in the supply chamber 143 and the collection chamber 144. The first conveying screw 140 and the second conveying screw 141 are screw members which are arranged substantially parallel to the rotational axis direction of the developing roller 132.

The partition wall 1360 includes a first opening portion 146 serving as a first communicating portion that communicates between the supply chamber 143 and the collection chamber 144 so as to allow the developer to move from the collection chamber 144 to the supply chamber 143, and a second opening portion 147 serving as a second communicating portion that communicates between the supply chamber 143 and the collection chamber 144 so as to allow the developer to move from the supply chamber 143 to the collection chamber 144. The first conveying screw 140 conveys the developer in a first direction from the first opening portion 146 toward the second opening portion 147 in the supply chamber 143. The second conveying screw 141 conveys the developer in a second direction from the second opening portion 147 toward the first opening portion 146 in the collection chamber 144.

The flow of the developer within the developing container 136 will be described with reference to FIG. 3. First, as indicated by an arrow a, the developer is supplied from the developer replenishment container (not shown) into the interior of the developing container 136 through the supply port 134. The developer that has been supplied to the developing container 136 is conveyed to the collection chamber 144 by the second conveying screw 141, as indicated by an arrow b. Next, the developer that has been conveyed to the collection chamber 144 is conveyed in the second direction toward the first opening portion 146 by the second conveying screw 141, as indicated by an arrow c. The developer that has reached the first opening portion 146 is pushed in by the second conveying screw 141, and thereby conveyed to the supply chamber 143, as indicated by an arrow d. The developer that has sent to the supply chamber 143 is conveyed in the first direction toward the second opening portion 147 by the first conveying screw 140, as indicated by an arrow e, and the developer that has reached the second opening portion 147 is sent to the collection chamber 144. As described above, the supply chamber 143 and the collection chamber 144 constitute a circulation pathway through which the developer circulates.

The developing apparatus 4A of the present embodiment is a so-called function-separated type developing apparatus that supplies the developer from the supply chamber 143 to the developing roller 132 and collects the developer in the collection chamber 144 from the developing roller 132. In addition, the developing apparatus 4A is a so-called vertical agitation type developing apparatus in which the supply chamber 143 is disposed above the collection chamber 144, and the developing roller 132 rotates downward in a gravitational direction at a position facing the photosensitive drum 1A.

In the function-separated type developing apparatus, the developer is conveyed from the upstream side to the downstream side in the conveyance direction of the developer within the collection chamber 144, and the developer is collected from the developing roller 132. Therefore, in the collection chamber 144, an amount of the developer tends to be greater on the downstream side as compared to the upstream side in the developer conveyance direction. In addition, in the function-separated type developing apparatus, the developer is conveyed from the upstream side to the downstream side in the developer conveyance direction within the supply chamber 143, and the developer is supplied to the developing roller 132. Therefore, in the supply chamber 143, the amount of developer tends to be less on the downstream side as compared to the upstream side in the developer conveyance direction. That is, as the developer circulates inside the developing container 136, a developer surface S of the developer T in the collection chamber 144 becomes higher toward the downstream side in the conveyance direction of the second conveying screw 141, namely the downstream side in the second direction. On the other hand, the developer surface S of the developer T in the supply chamber 143 becomes lower toward the downstream side in the conveyance direction of the first conveying screw 140, namely the downstream side in the first direction. Therefore, the developer surface S of the developer T becomes lower on the upstream side in the second direction within the collection chamber 144, and on the downstream side in the first direction within the supply chamber 143.

### Developing Roller

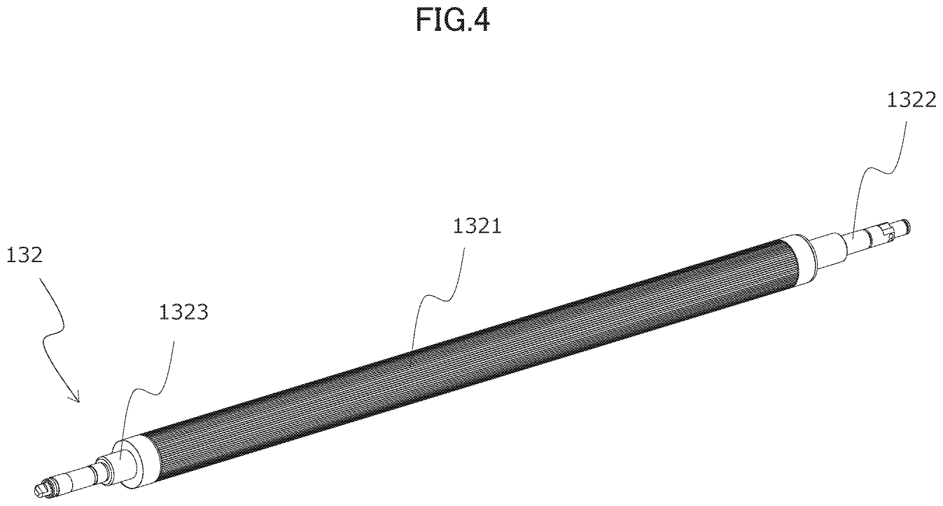

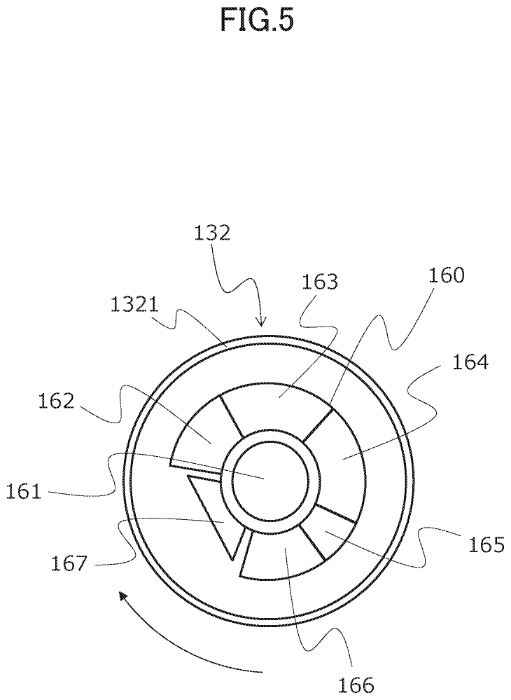

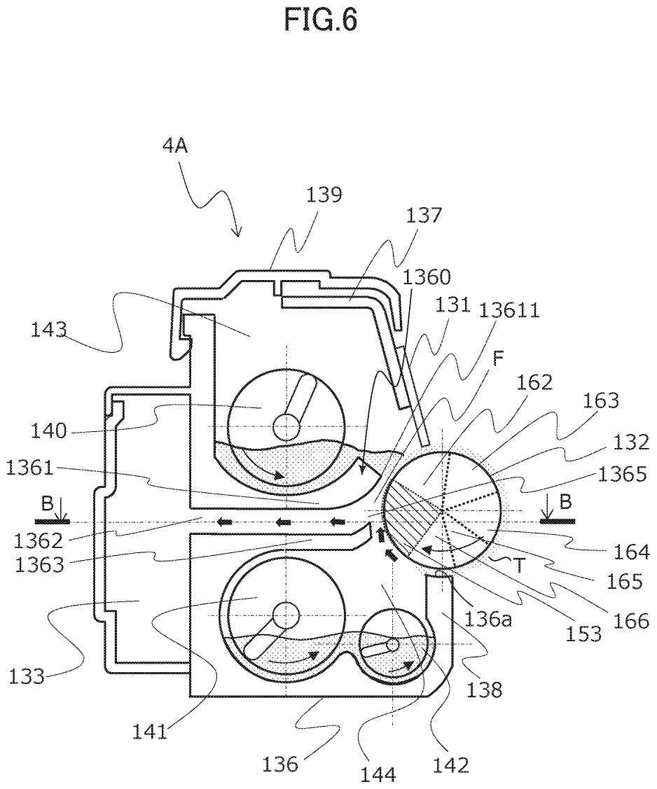

Next, the developing roller 132 will be described with reference to FIGS. 4, 5, and 6. FIG. 4 is a perspective view illustrating the developing roller 132 as a single unit. FIG. 5 is a cross-sectional view illustrating the developing roller 132 and a magnet roller 160 as viewed from the longitudinal direction. FIG. 6 is a cross-sectional view taken along the line A-A of FIG. 3. First, a configuration of the developing roller 132 will be described with reference to FIGS. 4 and 5. As illustrated in FIG. 4, the developing roller 132 includes a base tube 1321, formed of a non-magnetic material having a hollow cylindrical shape, and a rear flange 1322 and a front flange 1323, formed of a non-magnetic material similarly to the base tube 1321. The rear flange 1322 and the front flange 1323 each include a shaft-shaped portion and a cylindrical portion that join at an end portion of the base tube 1321 in the longitudinal direction. Inside the cylindrical portion, the flanges are fitted with the magnet roller 160, described later, through bearings.

As illustrated in FIG. 5, the magnet roller 160, serving as a magnet, non-rotationally disposed inside the developing roller 132. The magnet roller 160 includes a plurality of magnetic poles arranged in a rotational direction of the developing roller 132, and generates a magnetic field for causing the developing roller 132 to bear the developer. That is, the magnet roller 160 includes a five-pole fan-shaped magnet that forms, around a central shaft 161 extending in the longitudinal direction, a regulating pole 162 serving as a first magnetic pole, a conveying pole 163, a developing pole 164, a pick-up pole 165, and a peeling pole 166 serving as a second magnetic pole and a spacer 167.

A positional relationship between each magnetic pole will be described. The regulating pole 162 is disposed at a position opposite the regulation plate 131 with the developing roller 132 interposed therebetween. The regulating pole 162 may be arranged such that a peak position of a magnetic force of the regulating pole 162 on the surface of the developing roller 132 is located at a position opposite the regulation plate 131 with the developing roller 132 interposed therebetween, or may be arranged as follows. That is, the regulating pole 162 may be disposed at a position at which the peak position of the magnetic force of the regulating pole 162 on the surface of the developing roller 132 is located further upstream in the rotational direction of the developing roller 132 than the position facing the regulation plate 131 with the developing roller 132 interposed therebetween, and at which the peak position of the magnetic force described above is located above a rotation center of the developing roller 132 and further downstream in the rotational direction than a line which connects the rotation centers of the developing roller 132 and the first conveying screw 140.

The developing pole (third magnetic pole) 164 is positioned such that a peak position of a magnetic force of the developing pole 164 on the surface of the developing roller 132 is located below the rotation center of the developing roller 132 and further upstream in the rotational direction of the developing roller 132 than a line which connects the rotation centers of the developing roller 132 and the second conveying screw 141. The conveying pole 163 is disposed between the regulating pole 162 and the developing pole 164 so as to be positioned adjacent to the respective magnetic poles with respect to the rotational direction of the developing roller 132. With respect to the rotational direction of the developing roller 132, the pick-up pole 165 is disposed further downstream than the developing pole 164 so as to be positioned adjacent to the developing pole 164. With respect to the rotational direction of the developing roller 132, the peeling pole 166 is disposed downstream of the pick-up pole 165 so as to be positioned adjacent to the pick-up pole 165. With respect to the rotational direction of the developing roller 132, the spacer 167 is disposed between the regulating pole 162 and the peeling pole 166.

Next, a function of each magnetic pole and the flow of the developer will be described with reference to FIG. 6. Through the conveyance of the developer by the first conveying screw 140 described above, the developer within the supply chamber 143 is kicked up and supplied to the developing roller 132. The developer contains the magnetic carrier, therefore, the developer supplied to the developing roller 132 is retained by the magnetic force formed by the regulating pole 162. Next, in conjunction with the rotation of the developing roller 132, the developer passes through a position facing the regulation plate 131, and the developer on the developing roller 132 is regulated to a predetermined amount. That is, the layer thickness of the developer on the developing roller 132 is regulated. The developer having the layer thickness regulated passes through the conveying pole 163, is conveyed to the developing pole 164 facing the photosensitive drum 1A, and develops the electrostatic latent image on the photosensitive drum 1A.

The developer that has consumed the toner during development is drawn into the interior of the developing container 136 by the pick-up pole 165, and the developer retained on the developing roller 132 is separated by the peeling pole 166 and is collected into the collection chamber 144. The peeling pole 166 has the same polarity as the regulating pole 162, is positioned adjacent to the regulating pole 162, and separates the developer from the developing roller 132 by a repulsive magnetic field generated in cooperation with the regulating pole 162. In addition, in a region further upstream than the regulating pole 162 and further downstream than the peeling pole 166 with respect to the rotational direction of the developing roller 132, a low magnetic force zone 153 is formed as a low magnetic force portion in which the magnetic force (absolute value of the normal component Br of magnetic flux density) is equal to or less than 10 milli-Tesla (mT). The spacer 167, which is not a magnet, is disposed at a position corresponding to the low magnetic force zone 153. The low magnetic force zone 153 is a region in which a magnetic force becomes substantially zero, and a magnetic retaining force is not present; therefore, the developer does not adhere to the surface of the developing roller 132.

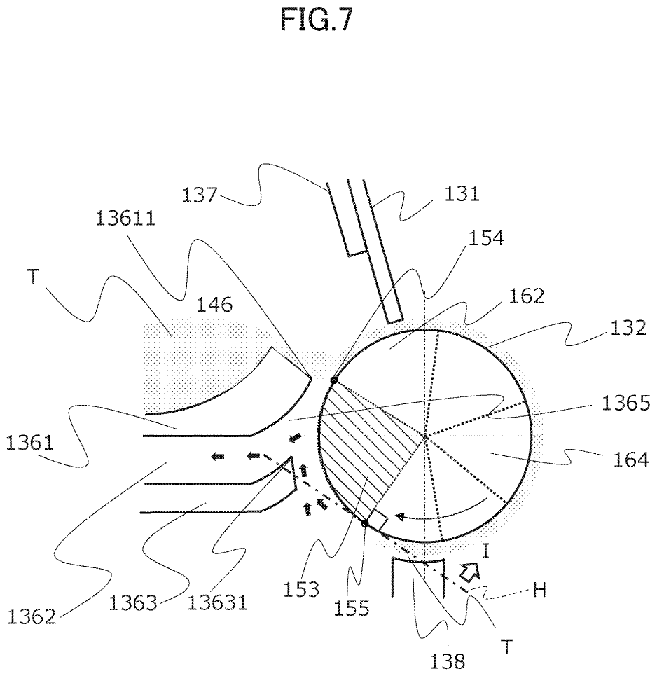

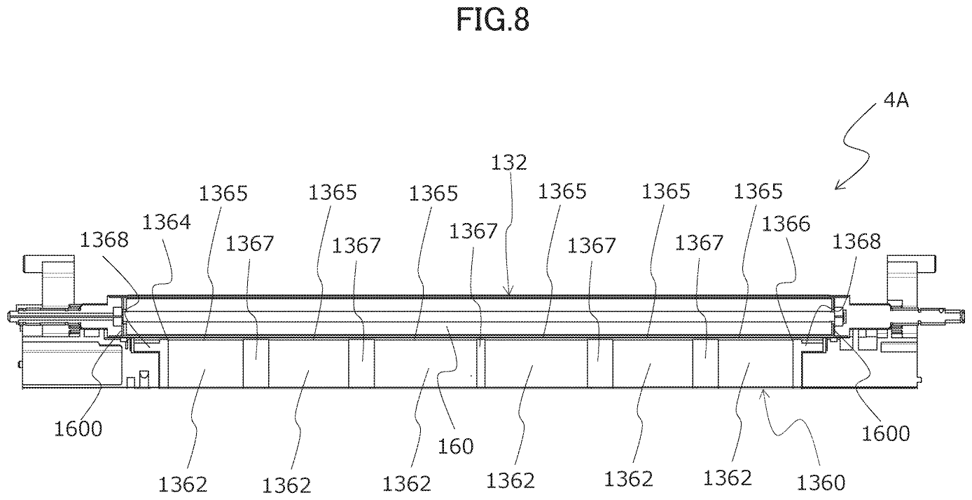

Next, a configuration of the partition wall 1360 in the developing apparatus 4A will be described with reference to FIGS. 6, 7, and 8. FIG. 7 is an enlarged view illustrating a portion of the partition wall 1360 of FIG. 6 on a side of the developing roller 132 and its adjacent area, for describing the configuration of the partition wall 1360. FIG. 8 is a cross-sectional view taken along the line B-B of FIG. 6, and is a schematic diagram illustrating a configuration of opening portions 1365 of the partition wall 1360.

The partition wall 1360 includes the opening portions 1365 and flow path portions 1362 for guiding air, which has flowed in through the opening portions 1365, to the outside of the developing container 136. The opening portions 1365 are formed at positions facing the low magnetic force zone 153 with the developing roller 132 interposed therebetween. The flow path portions 1362 are formed between a first partition wall portion 1361, facing a side of the supply chamber 143 of the partition wall 1360, and a second partition wall portion 1363, facing a side of the collection chamber 144 of the partition wall 1360, and communicate with the ventilation opening 133.

In the present embodiment, as illustrated in FIG. 8, the first partition wall portion 1361 and the second partition wall portion 1363 are connected by a plurality of connecting portions 1367 and 1368. The connecting portions 1368 connect the first partition wall portion 1361 and the second partition wall portion 1363 at both end portions in the longitudinal direction. The connecting portions 1367 each connect the first partition wall portion 1361 and the second partition wall portion 1363 at a plurality of locations closer to a center in the longitudinal direction than the connecting portions 1368 at both the ends are. Then, the opening portions 1365 and the flow path portions 1362 are formed between the connecting portions 1367 adjacent to each other in the longitudinal direction, and between the connecting portion 1368 and the connecting portion 1367 at both end portions in the longitudinal direction. To be noted, at least one or all of the plurality of connecting portions 1367 may be omitted. For example, the first partition wall portion 1361 and the second partition wall portion 1363 may be connected by the connecting portions 1368 at both the ends, or may be connected by the connecting portion 1367 at a center portion in the longitudinal direction in addition to the connecting portions 1368 at both the ends.

The opening portions 1365 of the flow path portions 1362 face the developing roller 132 as described above. Among end portions of each opening portion 1365 that face the developing roller 132, an opening end portion, or a downstream end portion, 13611 on the downstream side with respect to the rotational direction of the developing roller 132 is positioned to face the low magnetic force zone 153 with the developing roller 132 interposed therebetween. That is, the opening end portion 13611 of the first partition wall portion 1361 is disposed to face the low magnetic force zone 153 with the developing roller 132 interposed therebetween. In the present embodiment, the opening end portion 13611 is disposed at position facing a downstream end 154 of the low magnetic force zone 153 with the developing roller 132 in the rotational direction of the developing roller 132 interposed therebetween.

Further, among the end portions of the opening portion 1365 facing the developing roller 132, an opening end portion, or an upstream end portion, 13631 on the upstream side with respect to the rotational direction of the developing roller 132 is positioned in an arrow I direction, which is directed closer to a side of the rotation center of the developing roller 132 than a tangent line H of the developing roller 132 passing through a point at an upstream end 155 of the developing roller 132 of the low magnetic force zone 153 on the developing roller 132. That is, the opening end portion 13631 of the second partition wall portion 1363 is disposed, within a range facing the low magnetic force zone 153 with the developing roller 132 interposed therebetween, at an arbitrary position in a region further inward in the arrow I direction than the tangent line H of the upstream end 155, which is the starting point of the low magnetic force zone 153 on the developing roller 132.

Next, a relationship between the opening portions 1365 of the partition wall 1360 and the magnet roller 160 in the longitudinal direction (rotational axis direction) intersecting the rotational direction of the developing roller 132 will be described with reference to FIG. 8. With respect to the longitudinal direction of the developing roller 132, both end portions of the opening portions 1365 are positioned at locations facing the magnet roller 160 with the developing roller 132 interposed therebetween. That is, an upstream end portion 1364 and a downstream end portion 1366 of the opening portions 1365 in the longitudinal direction of the developing roller 132 are disposed at positions as close as possible to respective end portions 1600 on both sides in the longitudinal direction of the magnet roller 160 with the developing roller 132 interposed therebetween.

### Toner Scattering Mechanism

Next, a mechanism by which the toner scatters from inside the developing apparatus 4A to the outside will be described with reference to FIG. 6. As described above, the regulation plate 131 faces the regulating pole 162 with the developing roller 132 interposed therebetween. In addition, as described above, the developing roller 132 is disposed to face the photosensitive drum 1A through the opening 136a formed in the developing container 136. With respect to the rotational direction of the developing roller 132, a distal end of the wall portion 138, which constitutes a part of the opening 136a of the developing container 136, faces the developing roller 132 across a gap at a position upstream of the low magnetic force zone 153 and downstream of the position at which the developing roller 132 opposes the photosensitive drum 1A.

Airflow is generated in an area adjacent to the surface of the developing roller 132 due to the rotation of the developing roller 132. When the developer on the developing roller 132, which has completed development, is returned from between the developing roller 132 and the wall portion 138 toward the side of the collection chamber 144 within the developing container 136, air is drawn from outside the developing apparatus 4A in conjunction with the developer. The airflow generated by the rotation of the developing roller 132 passes through the collection chamber 144, passes through a region between the partition wall 1360 and the developing roller 132, and flows toward the supply chamber 143.

On the other hand, the developer within the supply chamber 143 adheres to the surface of the developing roller 132 by the regulating pole 162 of the developing roller 132. Thereby, a region between the opening end portion 13611 on the downstream side of the partition wall 1360 and the developing roller 132 is sealed by the developer borne on the developing roller 132. Therefore, in a case of a configuration in which, contrary to the present embodiment, the opening portions 1365 are not formed at the end portion of the partition wall 1360 on the side of the developing roller 132, the inflow of the airflow into the supply chamber 143 generated by the rotation of the developing roller 132 is suppressed by the developer between the opening end portion 13611 and the developing roller 132, as a result, the pressure within the collection chamber 144 is increased.

Then, as described above, the phenomenon, in which the air pressure within the collection chamber 144 increases due to the air drawn into the developing container 136, causes the air in the collection chamber 144 to be discharged to the outside of the developing container 136 through a gap between the developing roller 132 and the wall portion 138 so as to replace the air inside the developing container 136. At this time, the air inside the developing container 136 contains the toner which is floating internally; therefore, the floating toner may scatter outside the developing container 136 and the interior of the image forming apparatus and output products may be contaminated.

Here, as in Japanese Patent Laid-Open No. 2012-108234, a configuration is conceivable in which an opening portion is formed in a surface of a partition wall facing a collection chamber, and air flows from this opening portion to the outside of a developing apparatus. However, in a case where the opening portion is formed at this position, as described above, a portion of the opening portion may be obstructed by the developer scattering within the collection chamber, and the air may become difficult to flow to the outside through the opening portion, therefore, an increased pressure in the collection chamber may not be sufficiently reduced. In the configuration of Japanese Patent Laid-Open No. 2012-108234, to reduce the pressure increase in the collection chamber, it is conceivable to configure an area of the opening portion as large as possible such that the opening portion will not be obstructed by the scattering developer. However, the size of the partition wall is limited, and it is difficult to make the opening portion sufficiently large. In addition, it is also conceivable to separately dispose an exhaust fan or the like for drawing the air from the opening portion. However, in this case, the apparatus becomes larger and also manufacturing costs increase. In addition, in Japanese Patent Laid-Open No. 2012-108234, the toner may flow into the opening portion and scatter to the outside through the opening portion.

### Mechanism for Reducing Toner Scattering

Next, a mechanism for reducing the toner scattering according to the present embodiment will be described with reference to FIGS. 6 and 7. As described above, the developer between the opening end portion 13611 on the downstream side of the partition wall 1360 and the developing roller 132 may obstruct the airflow from the collection chamber 144 to the supply chamber 143. For this reason, a region F in which the partition wall 1360 and the developing roller 132 face each other becomes the most downstream portion of the airflow generated by the rotation of the developing roller 132, and becomes a region in which air pressure locally increases. Therefore, in the present embodiment, as illustrated in FIG. 6, the opening portions 1365 are disposed in the region where the partition wall 1360 faces the developing roller 132. In addition, the flow path portions 1362 are formed inside the partition wall 1360 for guiding the air that has flown in from the opening portions 1365 to the outside of the developing container 136. That is, in the present embodiment, by disposing the opening portions 1365 in the region F and bringing the opening portions 1365 into communication with the outside of the developing apparatus 4A through the flow path portions 1362, the airflow generated by the rotation of the developing roller 132, which flows into the region F, is guided to the outside of the developing apparatus 4A. Thereby, the pressure increase in the collection chamber 144 is reduced.

In addition, by arranging the opening portions 1365 at the positions facing the developing roller 132 adjacent to the region F, the area of the opening portions 1365 can be reduced compared to a case where opening portions are formed on a side facing a collection chamber as in Japanese Patent Laid-Open No. 2012-108234. That is, in Japanese Patent Laid-Open No. 2012-108234, since the opening portion is formed in the surface of the partition wall facing the collection chamber, unless an area of the opening portion is increased, the opening portion becomes obstructed by the developer scattering within the collection chamber, and the air is prevented from being sufficiently discharged to the outside through the opening portion. In contrast, in the present embodiment, since the opening portions 1365 are formed in the surface of the partition wall 1360 facing the developing roller 132, the opening portions 1365 are less likely to be obstructed by the developer scattering within the collection chamber 144. Therefore, even if the area of the opening portions 1365 is not increased, the air can be sufficiently discharged to the outside through the opening portions 1365. In addition, in the present embodiment, since the opening portions 1365 are positioned above the second partition wall portion 1363, which is arranged to face the second conveying screw 141, the toner kicked up by the second conveying screw 141 can be reduced from flowing into the opening portions 1365.

In particular, in the present embodiment, the opening portions 1365 are disposed at the positions facing the low magnetic force zone 153 with the developing roller 132 interposed therebetween. Thereby, a magnetic brush is eliminated at the positions facing the opening portions 1365, and the elimination of the magnetic brush can suppress the opening portions 1365 from being obstructed by the developer. Therefore, the air can be sufficiently discharged to the outside through the opening portions 1365. As a result, the pressure increase within the collection chamber 144 can be sufficiently reduced, and the air in the collection chamber 144 can be suppressed from being discharged to the outside of the developing container 136 through the gap between the developing roller 132 and the wall portion 138, thereby, the toner can be suppressed from scattering outside the developing container 136. In addition, since the opening portions 1365 are less likely to be obstructed by the developer, without increasing the area of the opening portions 1365, the air can be sufficiently discharged to the outside through the opening portions 1365, thereby, an increase in the size of the developing apparatus 4A can be suppressed. Further, the elimination of the magnetic brush at the positions facing the opening portions 1365 reduces the floating toner in the area adjacent to the opening portions 1365. Therefore, the toner flowing into the opening portion 1365 can be reduced. As a result, the toner can be suppressed from scattering to the outside through the opening portions 1365.

In addition, as illustrated in FIG. 7, within the range facing the low magnetic force zone 153, the opening end portion 13631 of the opening portion 1365 is disposed at arbitrary positions in the region closer to the side of the rotation center of the developing roller 132 than the tangent line H of the upstream end 155 of the low magnetic force zone 153 of the developing roller 132 is. The developing roller 132 separates the developer at the peeling pole 166, and conveys the developer to the collection chamber 144. However, the separated developer may receive inertia from the rotation of the developing roller 132 onto which the developer has been adhered, and may fly in the tangential direction from the upstream end (starting point) 155 of the low magnetic force zone 153. Therefore, by disposing the opening end portion 13631 above the height at which the developer flies, the inflow of the developer, which has been separated from the developing roller 132, into the opening portions 1365 can be reduced. As a result, the inflow of the developer into the opening portions 1365 can be further suppressed, and an effect of suppressing an increase in pressure loss at the opening portions 1365 can be obtained.

In addition, as illustrated in FIG. 8, in the present embodiment, the upstream and downstream end portions 1364 and 1366 of the opening portions 1365 in the longitudinal direction of the developing roller 132 are disposed at the positions adjacent to the end portions 1600, which are located on both the sides of the magnet roller 160 in the longitudinal direction, with the developing roller 132 interposed therebetween. Here, in the longitudinal direction of the developing roller 132, the region in which the airflow generated by the rotation of the developing roller 132 is present corresponds to a region in which the magnet roller 160 of the developing roller 132 is present. Therefore, in the longitudinal direction of the developing roller 132, a range in which the region between the developing roller 132 and the partition wall 1360 becomes a highest-pressure region corresponds to the region in which the magnet roller 160 of the developing roller 132 is present. Therefore, by disposing the opening portions 1365 in the region in which the magnet roller 160 of the developing roller 132 is present, an effect of preventing the pressure increase within the developing container 136 is obtained. As described above, in the present embodiment, with respect to the longitudinal direction of the developing roller 132, both the end portions of the opening portions 1365 are configured to face the magnet roller 160 with the developing roller 132 interposed therebetween, and the opening portions 1365 are configured to face the region in which the magnet roller 160 of the developing roller 132 is present.

According to the configuration of the present embodiment described above, by suppressing the increase in the air pressure in the collection chamber 144 while restraining the increase in the size of the developing apparatus 4A, the toner can be suppressed from scattering to the outside of the developing apparatus 4A.

### Second Embodiment

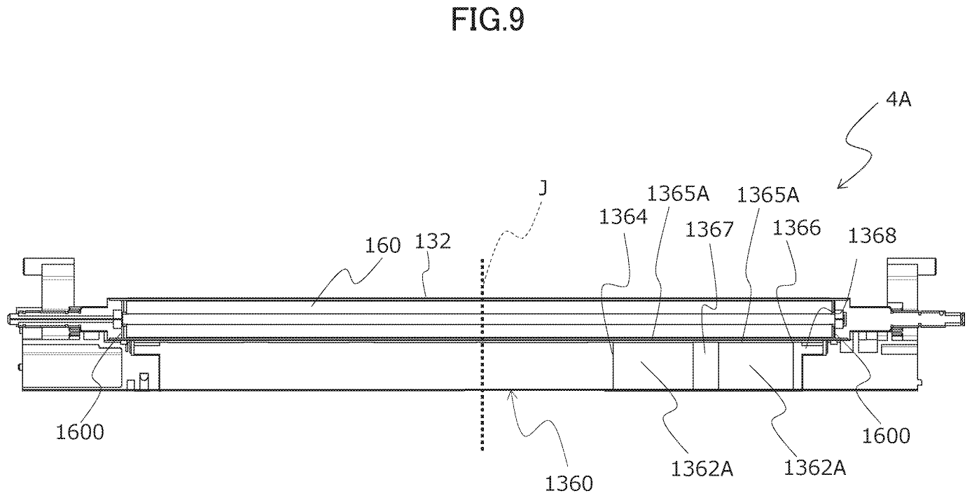

A second embodiment will be described with reference to FIG. 9. In the first embodiment described above, the upstream and downstream end portions 1364 and 1366 of the opening portions 1365 in the longitudinal direction of the developing roller 132 are disposed at the positions as close as possible to the end portions 1600, which are located on both the sides of the magnet roller 160 in the longitudinal direction, with the developing roller 132 interposed therebetween. In contrast, in the present embodiment, positions of opening portions 1365A are shifted further to one side than the center in the longitudinal direction. Since other configurations and operations are the same as those in the first embodiment described above, the same reference characters are denoted to similar configurations, and descriptions and illustrations thereof will be omitted or simplified. Hereinafter, differences from the first embodiment will be mainly described.

As described in FIG. 3 described above, the developer surface S of the developer T becomes lower on the upstream side in the second direction, which is the developer conveyance direction of the second conveying screw 141, within the collection chamber 144, and on the downstream side in the first direction, which is the developer conveyance direction of the first conveying screw 140, within the supply chamber 143. In regions in which the developer surface S is high, a portion of the developer separated by the peeling pole 166 may not be taken into the collection chamber 144, may reaches a region, in which the partition wall 1360 and the developing roller 132 face each other, following the rotation of the developing roller 132, and may be discharged outside the developing apparatus 4A through the opening portions 1365 of the partition wall 1360. For this reason, in the present embodiment, by disposing the opening portions 1365A of the partition wall 1360 in a region where the developer surface S is low, the discharge of the developer to the outside of the developing apparatus 4A is further suppressed.

That is, in the present embodiment, with respect to the longitudinal direction of the developing roller 132, both end portions of the opening portions 1365A are positioned to face the magnet roller 160 with the developing roller 132 interposed therebetween, and are located upstream of a center J of the magnet roller 160 in the second direction. That is, the upstream and downstream end portions 1364 and 1366 of the opening portions 1365A in the longitudinal direction of the developing roller 132 are positioned at positions facing the magnet roller 160 with the developing roller 132 interposed therebetween, and are located upstream of the center J of the magnet roller 160 in the second direction. In addition, flow path portions 1362A for allowing air, which has flowed in from the opening portions 1365A, to flow to the outside of the developing container 136 are similarly positioned upstream of the center J of the magnet roller 160 in the second direction.

In the present embodiment, by positioning the opening portions 1365A in this manner, the opening portions 1365A can be disposed in a region in which the developer surface S of the developer T becomes low in the collection chamber 144. Therefore, it is possible to suppress the developer conveyed by the second conveying screw 141 from being discharged to the outside through the opening portions 1365A. Therefore, also in the case of the configuration of the present embodiment, by suppressing the pressure increase in the collection chamber 144 while restraining the increase in the size of the developing apparatus 4A, the toner scattering to the outside of the developing apparatus 4A can be suppressed.

### Other Embodiments

In each of the embodiments described above, the configuration, i.e., the so-called function-separated configuration is described in which the developer is supplied from the supply chamber (first chamber) 143 to the developing roller (developer bearing member) 132, and the developer is collected from the developing roller 132 in the collection chamber (second chamber) 144 positioned on top of the supply chamber. However, in the function-separated configuration, the first chamber may not be disposed on top of the second chamber, and the positional relationship between the first and second chambers may be set as appropriate. For example, the first chamber may be positioned beneath the second chamber. In addition, the positional relationship between the first and second chambers may be diagonal. For example, the first chamber may be positioned diagonally on top of the second chamber.

The image forming apparatus of the present disclosure can be applied to copiers, printers, facsimile machines, multifunction peripherals including a plurality of these functions, and the like.

According to the present disclosure, it is possible to suppress toner scattering to the outside of the developing apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046979, filed Mar. 21, 2025, which is hereby incorporated by reference herein in its entirety.

What is claimed is:

1. A developing apparatus configured to develop an electrostatic latent image formed on an image bearing member with toner, the developing apparatus comprising:
a developer bearing member configured to bear and convey a developer containing the toner and a carrier;
a developing container configured to accommodate the developer, the developing container including:
a first chamber configured to accommodate the developer that is supplied to the developer bearing member;
a second chamber configured to collect the developer separated from the developer bearing member;
a partition wall configured to divide the first chamber and the second chamber, the partition wall including a first communicating portion configured to communicate between the second chamber and the first chamber such that the developer is allowed to move from the second chamber to the first chamber and a second communicating portion configured to communicate between the second chamber and the first chamber such that the developer is allowed to move from the first chamber to the second chamber;
a first conveyance member disposed in the first chamber and configured to convey the developer in a first direction from the first communicating portion toward the second communicating portion;
a second conveyance member disposed in the second chamber and configured to convey the developer in a second direction from the second communicating portion toward the first communicating portion; and
a magnet non-rotationally disposed inside the developer bearing member and including a plurality of magnetic poles arranged in a rotational direction of the developer bearing member, the magnet being configured to generate a magnetic field that allows the developer bearing member to bear the developer,
wherein the magnet includes a first magnetic pole and a second magnetic pole,
wherein the second magnetic pole is positioned adjacent to the first magnetic pole on an upstream side in the rotational direction of the developer bearing member, has a same polarity as the first magnetic pole, and is configured to separate the developer on the developer bearing member by a repulsive magnetic field generated in cooperation with the first magnetic pole,
wherein, a low magnetic force portion having a magnetic force of equal to or less than 10 milli-Tesla is formed in a region upstream of the first magnetic pole and downstream of the second magnetic pole in the rotational direction of the developer bearing member, and
wherein the partition wall includes an opening portion formed at a position facing the low magnetic force portion with the developer bearing member interposed therebetween, and a flow path portion configured to guide air entering from the opening portion to an outside of the developing container.

2. The developing apparatus according to claim 1,
wherein the opening portion includes an upstream end portion that faces the developer bearing member and a downstream end portion that faces the developer bearing member on a downstream side with respect to the upstream end portion in the rotational direction of the developer bearing member, and
wherein the downstream end portion is positioned at a position facing the low magnetic force portion with the developer bearing member interposed therebetween.

3. The developing apparatus according to claim 1,
wherein the developer bearing member is a developing roller formed in a cylindrical shape,
wherein the opening portion includes an upstream end portion that faces the developer bearing member and a downstream end portion that faces the developer bearing member on a downstream side with respect to the upstream end portion in the rotational direction of the developer bearing member, and
wherein the upstream end portion is positioned closer to a side of a rotation center of the developing roller than a tangent line of the developing roller passing through a point of an upstream end of the low magnetic force portion on the developing roller is.

4. The developing apparatus according to claim 1,
wherein, both end portions of the opening portion in a longitudinal direction intersecting the rotational direction of the developer bearing member are positioned at positions facing the magnet with the developer bearing member interposed therebetween.

5. The developing apparatus according to claim 1,
wherein, both end portions of the opening portion in a longitudinal direction intersecting the rotational direction of the developer bearing member are positioned at positions facing the magnet with the developer bearing member interposed therebetween, and are located upstream of a center of the magnet in the second direction.

6. The developing apparatus according to claim 1,
further comprising a regulation member disposed with a predetermined gap between the regulation member and the developer bearing member and configured to regulate a layer thickness of the developer borne on the developer bearing member,
wherein the regulation member faces the first magnetic pole with the developer bearing member interposed therebetween.

7. The developing apparatus according to claim 1,
wherein the developer bearing member is disposed so as to face the image bearing member through an opening formed in the developing container, and
wherein, a portion of the opening of the developing container faces the developer bearing member with a gap therebetween, at a position located upstream of the low magnetic force portion and downstream of a position where the developer bearing member faces the image bearing member, in the rotational direction of the developer bearing member.

8. The developing apparatus according to claim 1,
wherein the first chamber is disposed above the second chamber.
